(19) United States
(12) Patent Application Publication
(10) Pub. No.: US 2024/0091969 A1
(43) Pub. Date: Mar. 21, 2024

(54) DRIED FISH FLAKE MACHINE

(71) Applicant: MEDICAL FOUNDATION Co., Ltd, Shimizu-cho (JP)

(72) Inventor: Kiyoto HIROOKA, Shimizu-cho (JP)

(21) Appl. No.: 18/050,702

(22) Filed: Oct. 28, 2022

(30) Foreign Application Priority Data
Sep. 15, 2022 (JP) 2022-147146

(51) Int. Cl. B26D 3/28; A23L 17/10

(52) U.S. Cl. CPC B26D 3/28; A23L 17/10; A23V 2002/00

(57) ABSTRACT

A dried fish flake machine may be used with one hand, in which a shaving blade can be easily replaced, cleaned, and the like, and which can shave an edible shaving object such as dried bonito into a strip shape, a powder form, or the like. A dried fish flake machine includes a tubular case that is able to store an edible shaving object S having a rod shape; a shaving blade portion that is provided at a distal end of the tubular case, abuts a distal end of the edible shaving object, and is able to shave the edible shaving object; a rotary drive mechanism that is provided inside the tubular case and is able to relatively rotate the edible shaving object stored in the tubular case with respect to the shaving blade portion. The shaving blade portion is provided at the distal end of the tubular case in an attachable/detachable manner.

### PRIORITY CLAIM

The present disclosure claims priority to JP Patent Application Serial No. 2022-147146 filed on Sep. 15, 2022; the disclosure of which is incorporated herewith by reference.

### FIELD

The present disclosure relates to a dried fish flake machine capable of producing dried fish flakes by shaving dried bonito or the like.

### BACKGROUND

Dried fish flakes such as dried bonito flakes, which have been shaved in advance, are sold in packs or the like, but since they have little flavor, freshly shaved dried fish flakes are preferred at homes, restaurants, and the like. Conventionally, work of shaving dried fish has been manually performed using a plane-type dried bonito shaving machine, but since the shaving work is troublesome and time-consuming, devices for producing dried fish flakes by means of electric power or the like have been proposed.

For example, Patent Document 1 discloses a dried bonito shaving machine for household use constituted of a cutter that revolves around a dried bonito insertion hole while rotating on its axis and a drive mechanism for driving the cutter for shaving rod-shaped dried bonito.

In this dried bonito shaving machine for household use, when dried bonito which has been processed into a rod shape is inserted into the dried bonito insertion hole, the dried bonito is shaved by the cutter having a spiral blade rotated by the drive mechanism, and dried fish flakes are heaped up in a dried fish flake reception box. That is, the dried bonito shaving machine for household use in Patent Document 1 is a machine for shaving rod-shaped dried bonito in a manner of known electric pencil sharpeners in the related art.
Patent Document 1—Japanese Unexamined Utility Model Application Publication No. S55-80197.

### SUMMARY

Since conventional dried fish flake machines have constitutions similar to those of pencil sharpeners, they have large sizes in their entirety. In addition, there is a need to thrust rod-shaped dried fish into an insertion hole with one hand while the other is holding the device, and it is difficult to shave dried fish with only one hand while holding it with one hand.

In addition, since a cutter having a spiral blade is embedded inside a shaving machine, there are problems that detachment and replacement cannot be easily performed and it is difficult to perform cleaning and washing.

Moreover, cutters having a spiral blade used in the conventional dried fish flake machines sharpen a distal end of dried fish as in pencil sharpeners, and the object is shaved into a string shape, resulting in inconvenience that it is difficult to shave an object into a strip shape, a powder form, or the like.

The present disclosure relates to a dried fish flake machine which can be used with one hand, in which a shaving blade can be easily replaced, cleaned, and the like, and which can shave an edible shaving object such as dried bonito into a strip shape, a powder form, or the like.

According to a first exemplary embodiment of the present disclosure, a dried fish flake machine includes a tubular case that is able to store an edible shaving object having a rod shape; a shaving blade portion that is provided at a distal end of the tubular case, abuts a distal end of the edible shaving object, and is able to shave the edible shaving object; and a rotary drive mechanism that is provided inside the tubular case and is able to relatively rotate the edible shaving object stored in the tubular case with respect to the shaving blade portion. The shaving blade portion is provided at the distal end of the tubular case in an attachable/detachable manner.

In this dried fish flake machine, since the shaving blade portion is provided at the distal end of the tubular case in an attachable/detachable manner, the shaving blade portion can be detached and can be easily cleaned and washed, and it is also easily replaced with various kinds of shaving blade portions in accordance with an edible shaving object.

In addition, since the entire constitution including the edible shaving object is stored inside the tubular case, it can be miniaturized and has a handy shape which is easy to hold even with one hand, and it is also easy to directly sprinkle dried fish flakes over food ingredients or the like from the distal end of the tubular case while holding it with one hand. Moreover, a shaving blade portion such as a flat blade can be used without using a conventional cutter having a spiral blade, and thus dried fish flakes having a strip shape, a powder form, or the like can be obtained.

Since an edible shaving object can be taken out and input through the distal end of the tubular case in a state in which the shaving blade portion is detached from the tubular case, an edible shaving object such as dried bonito processed into a rod shape can be easily stored and replaced.

According to a second exemplary embodiment of present disclosure, in the dried fish flake machine according to the first exemplary embodiment, the tubular case is constituted of a distal end side cylinder portion which is able to store the edible shaving object, and a proximal end side piston portion which is able to advance or retreat inside the distal end side cylinder portion. A distal end of the proximal end side piston portion is able to abut a proximal end of the edible shaving object stored in the distal end side cylinder portion directly or with other members therebetween. The distal end of the edible shaving object is able to abut the shaving blade portion in a pressurized state by thrusting the proximal end side piston portion with respect to the distal end side cylinder portion.

That is, in this dried fish flake machine, since the distal end of the edible shaving object is able to abut the shaving blade portion in a pressurized state by thrusting the proximal end side piston portion with respect to the distal end side cylinder portion, a rotating edible shaving object can be pushed against the shaving blade portion, and thus dried fish flakes can be easily obtained.

According to a third exemplary embodiment of the present disclosure, in the dried fish flake machine according to the second exemplary embodiment, retaining stepped portions that are able to be interlocked with each other when the proximal end side piston portion protrudes from the distal end side cylinder portion by a certain length are respectively formed on an outer circumferential surface of the proximal end side piston portion and an inner circumferential surface of the distal end side cylinder portion.

That is, in this dried fish flake machine, since the retaining stepped portions able to be interlocked with each other when the proximal end side piston portion protrudes from the distal end side cylinder portion by a certain length are respectively formed on the outer circumferential surface of the proximal end side piston portion and the inner circumferential surface of the distal end side cylinder portion, the proximal end side piston portion can be prevented from falling out from the distal end side cylinder portion.

According to a fourth exemplary embodiment of the present disclosure, in the dried fish flake machine according to any one of the first to third exemplary embodiments, the rotary drive mechanism includes a motor, and an attachment portion which is fixed to a rotary shaft of the motor, allows the edible shaving object stored in the tubular case to rotate together with the rotary shaft, and abuts a proximal end of the edible shaving object.

That is, in this dried fish flake machine, since there is provided the attachment portion which is fixed to the rotary shaft of the motor, allows the edible shaving object stored in the tubular case to rotate together with the rotary shaft, and abuts the proximal end of the edible shaving object, an edible shaving object can be prevented from slipping out with respect to the rotating rotary shaft by the attachment portion.

According to a fifth exemplary embodiment of the present disclosure, in the dried fish flake machine according to the fourth exemplary embodiment, the rotary drive mechanism includes a switch for driving the motor when being pressed at a proximal end of the tubular case.

That is, in this dried fish flake machine, since the rotary drive mechanism includes the switch for driving the motor when being pressed at the proximal end of the tubular case, when the tubular case is grasped and held by one hand, the switch at the proximal end of the tubular case can be pressed with the thumb, the index finger, or the like, and rotation can be easily switched between ON and OFF with one hand.

According to a sixth exemplary embodiment of the present disclosure, the dried fish flake machine according to the fourth exemplary embodiment further includes a base member that is attached to a proximal end of the edible shaving object. At least one of the base member and the attachment portion has a magnet. The other of the base member and the attachment portion has a magnet or a metal piece which is able to be attracted by the magnet. The attachment portion is able to be attached to the base member and is able to be attracted by the base member due to a magnetic force of the magnet.

That is, in this dried fish flake machine, since the attachment portion is able to be attached to the base member and is able to be attracted by the base member due to a magnetic force of the magnet, when the proximal end side piston portion is pulled out, an edible shaving object is attracted by a magnetic force. Therefore, it is difficult for an edible shaving object to fall off from the attachment portion.

The dried fish flake machine of the present disclosure, since the shaving blade portion is provided at the distal end of the tubular case in an attachable/detachable manner, the shaving blade portion can be detached and can be easily cleaned and washed, and it is also possible to be replaced with various kinds of shaving blade portions in accordance with an edible shaving object.

In addition, since it can be used by holding it with one hand, a shaving blade portion such as a flat blade can be used, and thus an edible shaving object can be shaved into a strip shape, a powder form, or the like.

### BRIEF DESCRIPTION OF DRAWINGS

FIG. 1 is a cross-sectional view illustrating an embodiment of a dried fish flake machine according to the present disclosure.

FIG. 2 is a front view illustrating the dried fish flake machine according to the present embodiment.

FIG. 3A is a top view illustrating the dried fish flake machine according to the present embodiment.

FIG. 3B is a bottom view illustrating the dried fish flake machine according to the present embodiment.

FIG. 4 is a cross-sectional view of the dried fish flake machine illustrating a state when a proximal end side piston portion is detached and an edible shaving object is taken out in the present embodiment.

FIG. 5 is a cross-sectional view of the dried fish flake machine illustrating a state when a shaving blade portion is detached and the edible shaving object is taken out in the present embodiment.

FIG. 6A is a perspective view illustrating a shaving object case storing an edible shaving object in another example of the present embodiment.

FIG. 6B is a perspective view illustrating an attachment portion in another example of the present embodiment.

FIG. 7A is a plan view illustrating a base member in another example of the present embodiment.

FIG. 7B is a longitudinal sectional view of the shaving object case storing the edible shaving object in another example of the present embodiment.

### DETAILED DESCRIPTION

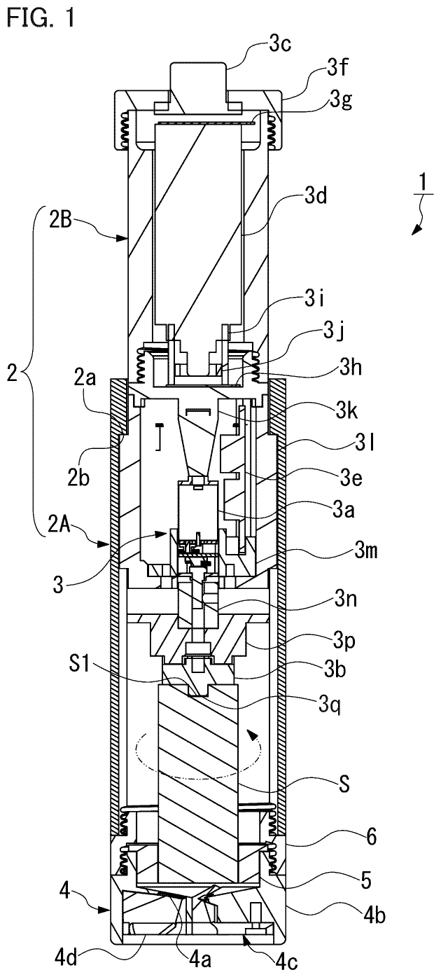

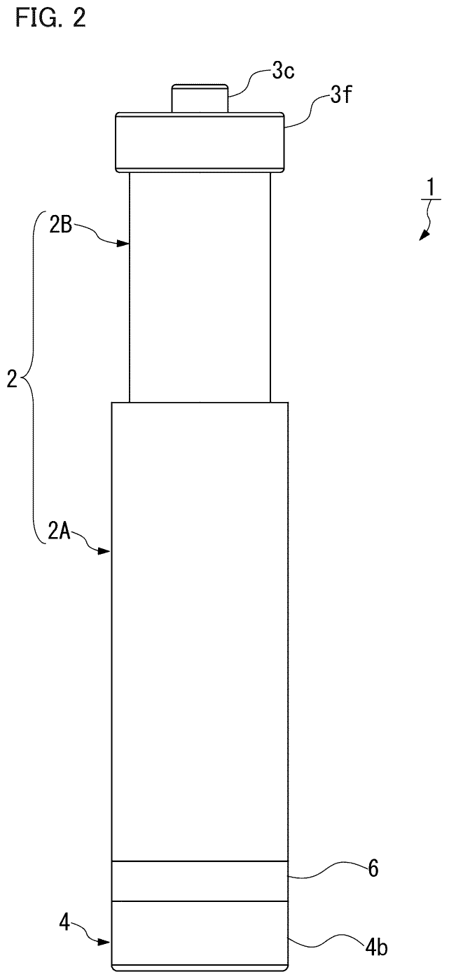

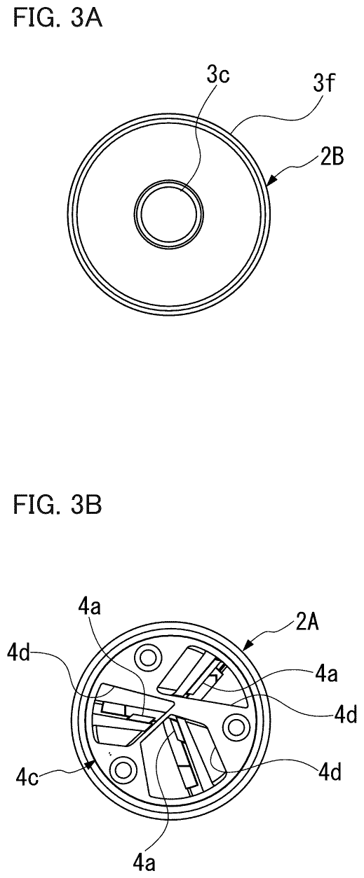

Hereinafter, an embodiment of a dried fish flake machine according to the present disclosure will be described with reference to FIGS. 1 to 5.

As illustrated in FIGS. 1 to 5, a dried fish flake machine 1 according to the present embodiment includes a tubular case 2 that can store an edible shaving object S having a rod shape; a shaving blade portion 4 that is provided at a distal end of the tubular case 2, abuts a distal end of the edible shaving object S, and can shave the edible shaving object S; and a rotary drive mechanism 3 that is provided inside the tubular case 2 and can relatively rotate the edible shaving object S stored in the tubular case 2 with respect to the shaving blade portion 4.

The shaving blade portion 4 is provided at the distal end of the tubular case 2 in an attachable/detachable manner.

The tubular case 2 is constituted of a distal end side cylinder portion 2A which can store the edible shaving object S, and a proximal end side piston portion 2B which can advance or retreat inside the distal end side cylinder portion 2A.

A distal end of the proximal end side piston portion 2B can abut a proximal end of the edible shaving object S stored in the distal end side cylinder portion 2A directly or with other members therebetween. The distal end of the edible shaving object S can abut the shaving blade portion 4 in a pressurized state by thrusting the proximal end side piston portion 2B with respect to the distal end side cylinder portion 2A.

In the present embodiment, the distal end of the proximal end side piston portion 2B can abut the proximal end of the edible shaving object S stored in the distal end side cylinder portion 2A with other members (an attachment portion 3b, a coupling member 3n, and a dried fish flake stage member 3p, which will be described below) therebetween.

Retaining stepped portions 2a and 2b which can be interlocked with each other when the proximal end side piston portion 2B protrudes from the distal end side cylinder portion 2A by a certain length are respectively formed on an outer circumferential surface of the proximal end side piston portion 2B and an inner circumferential surface of the distal end side cylinder portion 2A described above.

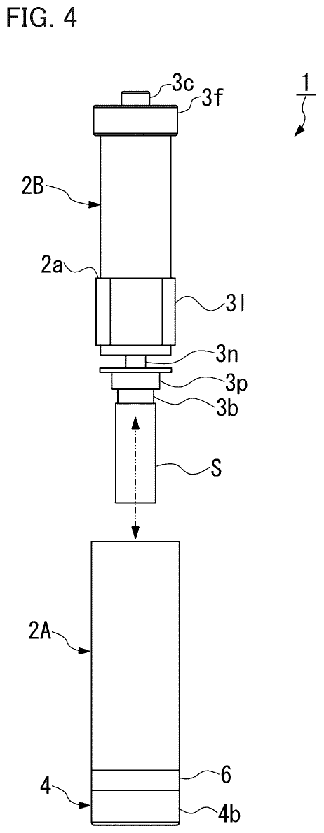

Both the retaining stepped portions 2a and 2b are not formed throughout the whole circumference and are formed to partially protrude in a circumferential direction. As illustrated in FIG. 4, the proximal end side piston portion 2B can be pulled out to a proximal end side from the distal end side cylinder portion 2A by relatively turning the proximal end side piston portion 2B and the distal end side cylinder portion 2A to positions where the retaining stepped portions 2a and 2b do not face each other.

That is, the stored edible shaving object S can be taken out by pulling out the proximal end side piston portion 2B from the distal end side cylinder portion 2A.

The rotary drive mechanism 3 includes a motor 3a, and the attachment portion 3b which is fixed to a rotary shaft of the motor 3a, allows the edible shaving object S stored in the tubular case 2 to rotate together with the rotary shaft, and abuts the proximal end of the edible shaving object S.

The motor 3a is a geared motor for rotating the edible shaving object S about an axis.

In addition, the rotary drive mechanism 3 includes a switch 3c for driving the motor 3a when being pressed at a proximal end of the tubular case 2.

That is, the switch 3c is a push switch for turning on and off the motor 3a.

For example, the foregoing edible shaving object S is a shaving object such as dried fish obtained by processing dried bonito, fish paste, dried chicken, or the like into a rod shape such as a rectangular column or a circular column.

The rotary drive mechanism 3 includes a battery portion 3d which is stored in the proximal end side piston portion 2B and stores, for example, AA-size batteries (three) or the like for driving the motor 3a inside a battery case, and a booster circuit 3e which is electrically connected to the battery portion 3d and the motor 3a.

The switch 3c is attached in a manner of protruding outward through a penetration hole of a switch cover 3f attached to a proximal end of the proximal end side piston portion 2B.

A negative electrode portion 3g which is in contact with a negative side end portion of the battery portion 3d while being in a state of facing the switch 3c with a gap therebetween is installed on a lower surface side of the switch 3c.

A positive electrode portion 3h is installed on a distal end side of the battery portion 3d while being in a state of facing the battery portion 3d with a gap therebetween.

In addition, a coil spring 3i for biasing the battery portion 3d and the positive electrode portion 3h in a direction in which they are separated from each other, and a spring guide 3j for supporting the coil spring 3i are attached to a distal end portion of the battery portion 3d.

Therefore, when the switch 3c is pushed down, the battery portion 3d is pushed down to the distal end side against a biasing force of the coil spring 3i, and a positive side end portion of the battery portion 3d comes into contact with the positive electrode portion 3h, which is thereby electrically conducted. Therefore, electric power is supplied to the motor 3a via the booster circuit 3e, and thus the motor 3a can be rotatively driven.

A motor pressing member 3k is installed between the positive electrode portion 3h and the motor 3a.

In addition, the proximal end side piston portion 2B includes a motor cover 3l for storing the motor 3a together with the booster circuit 3e at the distal end portion thereof.

The retaining stepped portion 2a is formed on an outer circumferential surface of the motor cover 3l.

A distal end portion of the motor 3a is supported by a motor holder 3m, and the coupling member 3n is fixed to the rotary shaft of the motor 3a.

The dried fish flake stage member 3p is fixed to a distal end side of the coupling member 3n, and the attachment portion 3b is fixed to a distal end side of the dried fish flake stage member 3p.

The attachment portion 3b has projection portions 3q, which can be inserted into insertion holes S1 formed on a proximal end surface of the edible shaving object S, on the distal end side thereof.

In the present embodiment, two insertion holes S1 are formed on the proximal end surface of the edible shaving object S, and two projection portions 3q corresponding to the two insertion holes S1 are formed in the attachment portion 3b. Accordingly, the edible shaving object S can be rotated without being misaligned with respect to the rotating attachment portion 3b.

The insertion holes S1 having a polygonal cross section (a triangular shape, a rectangular shape, or the like) may be formed on the proximal end surface of the edible shaving object S, and the projection portions 3q having a polygonal cross section corresponding to the insertion holes S1 having a polygonal cross section may be formed in the attachment portion 3b.

The attachment portion 3b is set such that the projection portions 3q are fitted into the insertion holes S1 in an adhering manner to the extent that the edible shaving object S does not easily come off.

In addition, the edible shaving object S may be processed to have a polygonal cross section such as a rectangular column, and an attachment portion having a recessed shape with a polygonal cross section into which a proximal end portion of the edible shaving object S can be fitted may be employed.

An annular dried fish flake guide 5 for supporting the outer circumference of the stored edible shaving object S, and a guide holder 6 for supporting a part around the dried fish flake guide 5 are installed in a distal end portion of the distal end side cylinder portion 2A.

The guide holder 6 has a male screw portion which can be screwed into a female screw hole formed on an inner circumferential surface of the distal end portion of the distal end side cylinder portion 2A and is screwed to the distal end portion of the distal end side cylinder portion 2A in an attachable/detachable manner.

In addition, the shaving blade portion 4 has a male screw portion which can be screwed into a female screw hole formed on an inner circumferential surface of the guide holder 6 and is screwed to a distal end side of the guide holder 6 in an attachable/detachable manner in a state of sandwiching the dried fish flake guide 5 therebetween.

The shaving blade portion 4 includes three flat blades 4a which can abut the distal end of the edible shaving object S, a blade holder 4b which supports these flat blades 4a from an outer circumferential side, and a blade pressing member 4c which supports the three flat blades 4a from the distal end side.

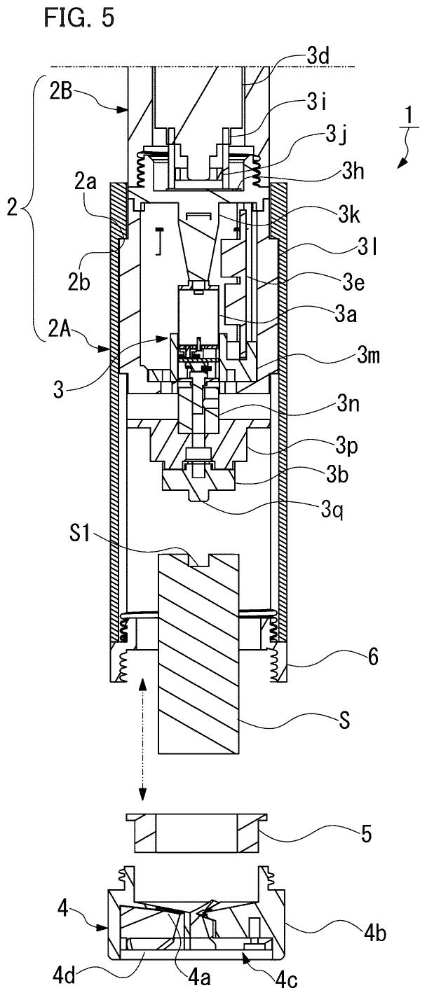

In the blade holder 4b, a male screw portion is formed in an upper portion thereof and is screwed to a female screw portion formed in a lower portion of the guide holder 6 in an attachable/detachable manner. That is, as illustrated in FIG. 5, the shaving blade portion 4 can be detached from the distal end side cylinder portion 2A together with the dried fish flake guide 5 by rotating the blade holder 4b and detaching it from the guide holder 6.

An opening portion 4d is formed immediately below the flat blades 4a in the blade pressing member 4c so that shaved dried fish flakes fall out through the opening portion 4d.

In the present embodiment, the shaving blade portion 4 having the three flat blades 4a is provided, but a shaving blade portion having one blade or a shaving blade portion having a plurality of blades other than three may be employed.

In the dried fish flake machine 1 of the present embodiment, the edible shaving object S is taken out and replaced as follows.

First, retention is canceled by relatively turning the proximal end side piston portion 2B and the distal end side cylinder portion 2A about the axis to positions where the retaining stepped portions 2a and 2b do not face each other.

Next, as illustrated in FIG. 4, the proximal end side piston portion 2B is pulled out from the distal end side cylinder portion 2A from the proximal end side thereof. At this time, the edible shaving object S attached to the distal end of the proximal end side piston portion 2B is also taken out so that it can be replaced with another edible shaving object S.

If another edible shaving object S is stored after replacement, the foregoing procedure is reversely performed. That is, the proximal end side piston portion 2B in which a new edible shaving object S is attached to the distal end with the attachment portion 3b therebetween is inserted into the distal end side cylinder portion 2A. Moreover, the proximal end side piston portion 2B is retained and the edible shaving object S at the distal end is stored inside the distal end side cylinder portion 2A by relatively turning the proximal end side piston portion 2B and the distal end side cylinder portion 2A to the positions where the retaining stepped portions 2a and 2b face each other.

In the dried fish flake machine 1 of the present embodiment, as illustrated in FIG. 5, the edible shaving object S can also be taken out and input from the distal end of the tubular case 2 in a state in which the shaving blade portion 4 is detached from the tubular case 2.

As described above, in the dried fish flake machine 1 of the present embodiment, since the shaving blade portion 4 is provided at the distal end of the tubular case 2 in an attachable/detachable manner, the shaving blade portion 4 can be detached and can be easily cleaned and washed, and it is also easily replaced with various kinds of shaving blade portions 4 in accordance with the edible shaving object S.

In addition, since the entire constitution including the edible shaving object S is stored inside the tubular case 2, it can be miniaturized and has a handy shape which is easy to hold even with one hand, and it is also easy to directly sprinkle dried fish flakes over food ingredients or the like from the distal end of the tubular case 2 while holding it with one hand. Moreover, a shaving blade portion 4 such as a flat blade can be used without using a conventional cutter having a spiral blade, and thus dried fish flakes having a strip shape, a powder form, or the like can be obtained.

In addition, since the distal end of the edible shaving object S can abut the shaving blade portion 4 in a pressurized state by thrusting the proximal end side piston portion 2B with respect to the distal end side cylinder portion 2A, the rotating edible shaving object S can be pushed against the shaving blade portion 4, and thus dried fish flakes can be easily obtained.

Moreover, since the retaining stepped portions 2a and 2b which can be interlocked with each other when the proximal end side piston portion 2B protrudes from the distal end side cylinder portion 2A by a certain length are respectively formed on the outer circumferential surface of the proximal end side piston portion 2B and the inner circumferential surface of the distal end side cylinder portion 2A, the proximal end side piston portion 2B can be prevented from falling out from the distal end side cylinder portion 2A.

In addition, since there is provided the attachment portion 3b which is fixed to the rotary shaft of the motor 3a, allows the edible shaving object S stored in the tubular case 2 to rotate together with the rotary shaft, abuts the proximal end of the edible shaving object S, the edible shaving object S can be prevented from slipping out with respect to the rotating rotary shaft by the attachment portion 3b.

In addition, since the rotary drive mechanism 3 includes the switch 3c for driving the motor 3a when being pressed at the proximal end of the tubular case 2, when the tubular case 2 is grasped and held by one hand, the switch 3c at the proximal end of the tubular case 2 can be pressed with the thumb, the index finger, or the like, and rotation can be easily switched between ON and OFF with one hand.

The present disclosure is not limited to the foregoing embodiment, and various changes can be added thereto within a range not departing from the gist of the present disclosure.

For example, in the foregoing embodiment, an edible shaving object having a rod shape is shaved by rotating it such that it abuts the blade of the fixed shaving blade portion, but any constitution may be employed as long as an edible shaving object is relatively rotated with respect to the shaving blade portion. That is, a constitution in which a fixed edible shaving object having a rod shape is shaved by rotating the shaving blade portion such that it abuts the edible shaving object, or an edible shaving object is shaved by rotating the edible shaving object and the shaving blade portion in directions opposite to each other such that they abut each other may be employed.

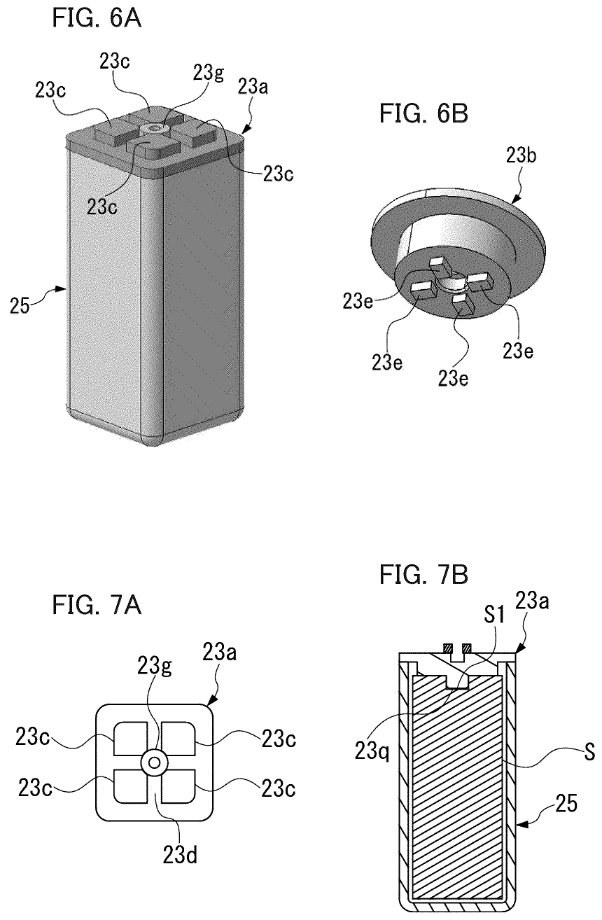

In addition, in the foregoing embodiment, the edible shaving object S having a rod shape is attached to the distal end of the proximal end side piston portion 2B with the attachment portion 3b therebetween. However, as another example of the foregoing embodiment, for example, as illustrated in FIGS. 6A and 6B and FIGS. 7A and 7B, the edible shaving object S may also be attached to the distal end of the proximal end side piston portion by means of a magnetic force by attaching a base member 23a having a magnet 23g to the proximal end of the edible shaving object S in advance and attaching an attachment portion 23b made of a magnetic or a metal piece allowing the base member 23a to be stuck thereon to the distal end of the proximal end side piston portion due to a magnetic force.

That is, in another example of the foregoing embodiment, the dried fish flake machine includes the base member 23a which is attached to the proximal end of the edible shaving object S. At least one of the base member 23a and the attachment portion 23b has the magnet 23g, and the other of the base member 23a and the attachment portion 23b has a magnet or a metal piece which can be attracted by the magnet 23g. The attachment portion 23b can be attached to the base member 23a and can be attracted by the base member 23a due to a magnetic force of the magnet 23g.

This attachment portion 23b is formed using a magnet or a metal piece.

As illustrated in FIGS. 7A and 7B, the base member 23a has projection portions 23q which can be fitted into the insertion holes S1 formed at the proximal end of the edible shaving object S on the distal end side, and the magnet 23g is fixed in the middle on the proximal end side. Four base side protrusion portions 23c having a rectangular shape are formed therearound.

Cross-shaped groove portions 23d are formed between the four base side protrusion portions 23c.

In the attachment portion 23b, as illustrated in FIG. 6B, four attachment side protrusion portions 23e corresponding to the cross-shaped groove portions 23d are formed on the distal end surface. That is, the four attachment side protrusion portions 23e are fitted into the cross-shaped groove portions 23d in a manner of a Phillips screwdriver such that a rotation force can be efficiently transferred.

In this manner, the base member 23a is attached to the attachment portion 23b and they are attracted by each other due to a magnetic force of the magnet 23g by fitting the four attachment side protrusion portions 23e into the cross-shaped groove portions 23d.

Moreover, as illustrated in FIG. 6A, the edible shaving object S taken out from the dried fish flake machine can be stored in an edible shaving object case 25 while remaining in a state in which the base member 23a is attached.

The edible shaving object case 25 has a rectangular tubular shape having a closed distal end, and the proximal end opening portion can be closed by the base member 23a.

In this manner, in this dried fish flake machine of another example, since the attachment portion 23b can be attached to the base member 23a and can be attracted by the base member 23a due to a magnetic force of the magnet 23g, when the proximal end side piston portion is pulled out, the edible shaving object S is attracted by a magnetic force. Therefore, it is difficult for the edible shaving object S to fall off from the attachment portion 23b.

In addition, the edible shaving object S can be stored inside the edible shaving object case 25 and the edible shaving object S which has been taken out can be protected and can also be favorably preserved by covering the edible shaving object S with the base member 23a which has been taken out with the edible shaving object case 25 having a closed distal end from the distal end side and closing the proximal end opening portion of the edible shaving object case 25 with the base member 23a.

This application claims the benefit of Japanese Patent Application No. 2022-147146, filed Sep. 15, 2022, which is hereby incorporated by reference wherein in its entirety.

### EXPLANATION OF REFERENCES

1 Dried fish flake machine
2 Tubular case
2A Distal end side cylinder portion
2B Proximal end side piston portion
2a, 2b Retaining stepped portion
3 Rotary drive mechanism
3a Motor
3b, 23b Attachment portion
3c Switch
4 Shaving blade portion
23a Base member
S Edible shaving object

What is claimed is:

1. A dried fish flake machine, comprising:
a tubular case configured to store an edible shaving object having a rod shape;
a shaving blade portion provided at a distal end of the tubular case and abuts a distal end of the edible shaving object, the shaving blade portion configured to shave the edible shaving object; and
a rotary drive mechanism provided inside the tubular case and configured to relatively rotate the edible shaving object stored in the tubular case with respect to the shaving blade portion,
wherein the shaving blade portion is provided at the distal end of the tubular case in an attachable/detachable manner.

2. The dried fish flake machine according to claim 1,
wherein the tubular case is constituted of a distal end side cylinder portion which configured to store the edible shaving object, and a proximal end side piston portion which is configured to advance or retreat inside the distal end side cylinder portion,
wherein a distal end of the proximal end side piston portion is configured to abut a proximal end of the edible shaving object stored in the distal end side cylinder portion directly or with other members therebetween, and
wherein the distal end of the edible shaving object is configured to abut the shaving blade portion in a pressurized state by thrusting the proximal end side piston portion with respect to the distal end side cylinder portion.

3. The dried fish flake machine according to claim 2, wherein retaining stepped portions that are configured to be interlocked with each other when the proximal end side piston portion protrudes from the distal end side cylinder portion by a certain length are respectively formed on an outer circumferential surface of the proximal end side piston portion and an inner circumferential surface of the distal end side cylinder portion.

4. The dried fish flake machine according to claim 1, wherein the rotary drive mechanism includes:
a motor, and
an attachment portion fixed to a rotary shaft of the motor, allows the edible shaving object stored in the tubular case to rotate together with the rotary shaft, and abuts a proximal end of the edible shaving object.

5. The dried fish flake machine according to claim 4, wherein the rotary drive mechanism includes a switch configured to drive the motor when being pressed at a proximal end of the tubular case.

6. The dried fish flake machine according to claim 4, further comprising:
a base member attached to the proximal end of the edible shaving object,
wherein at least one of the base member and the attachment portion has a magnet,
wherein the other of the base member and the attachment portion has a magnet or a metal piece which is configured to be attracted by the magnet, and
wherein the attachment portion is configured to be attached to the base member and is able to be attracted by the base member due to a magnetic force of the magnet.
